(19) United States
(12) Patent Application Publication
(10) Pub. No.: US 2012/0193297 A1
(43) Pub. Date: Aug. 2, 2012

(54) METHOD AND APPARATUS FOR CONTINUOUS FLOW MEMBRANE-LESS ALGAE DEWATERING

(75) Inventors: Meng H. Lean, Santa Clara, CA (US); David K. Fork, Los Altos, CA (US); Jeonggi Seo, Albany, CA (US); John S. Fitch, Los Altos, CA (US); Armin R. Volkel, Mountain View, CA (US)

(73) Assignee: PALO ALTO RESEARCH CENTER INCORPORATED, Palo Alto, CA (US)

(21) Appl. No.: 13/443,231

(22) Filed: Apr. 10, 2012

Related U.S. Application Data
(62) Division of application No. 12/484,071, filed on Jun. 12, 2009.

(51) Int. Cl. C02F 1/52

(52) U.S. Cl. 210/738

(57) ABSTRACT

In one aspect of the presently described embodiments, the system comprises an inlet to receive at least a portion of the fluid containing algae, a curved channel within which the fluid containing algae flows in a manner such that the neutrally buoyant algae flow in a band offset from a center of the curved channel, a first outlet for the fluid with algae within which the band flows, and, a second outlet for the remaining fluid.

This application claims the priority, as a divisional, of U.S. application Ser. No. 12/484,071, filed Jun. 12, 2009 (U.S. Patent Publication No. 2010-0314323, published Dec. 16, 2010), the disclosure of which is incorporated herein by reference in its entirety.

### CROSS REFERENCE TO RELATED PATENTS AND APPLICATIONS

Cross Reference is hereby made to related patent applications, U.S. Patent Publication No. 2010-0314327, published Dec. 16, 2010, by Lean et al., entitled, “Platform Technology For Industrial Separations”; U.S. Patent Publication No. 2010-0314325-US-NP, published Dec. 16, 2010, by Lean et al., entitled, “Spiral Mixer for Floc Conditioning”; and U.S. Patent Publication No. 2010-0314263, published Dec. 16, 2010, by Lean et al., entitled, “Stand-Alone Integrated Water Treatment System for Distributed Water Supply to Small Communities”, the specifications of which are each incorporated by reference herein in their entirety.

### BACKGROUND

Biofuel is emerging as a viable alternative to increasingly expensive fossil fuels. Certain types of algae provide a high percentage of oil and can be inexpensive to cultivate. However, the least cost-effective segment of the processing is in dewatering the algae prior to oil extraction. Conventional methods have included surface skimming, centrifugation and membrane filtration, all of which are labor intensive and/or power hungry.

Algae may be grown in a variety of settings. One setting where algae are typically found is in lakes and ponds. Harvesting algae from lakes and other natural settings is challenging, in part because of the low concentrations that are found in uncontrolled growing conditions.

Another source of algae is specially constructed outdoor ponds.

Two distinct methods of aquaculture for such ponds are known as intensive mode and extensive mode. Both aquacultural techniques require the addition of fertilizers to the medium (e.g., water) to supply the necessary inorganic nutrients, phosphorous, nitrogen, iron, and trace metals, that are necessary for biomass production through photosynthesis.

The primary difference between the two modes of production is mixing of the growth medium. Intensive ponds employ mechanical mixing devices while extensive ponds rely on mixing by the wind. Therefore, factors that affect algae growth can be more accurately controlled in intensive aquaculture.

Outdoor ponds for intensive aquaculture typically are expensive and are frequently constructed of concrete and lined with plastic. A number of configurations of the ponds have been proposed for intensive aquaculture. However, the open air raceway ponds are typically the most important commercially. Raceway ponds employ paddle wheels to provide mixing. Chemical and biological parameters are carefully controlled.

Outdoor ponds for extensive aquaculture generally are larger than those for intensive aquaculture and normally are constructed in lake beds. The open air ponds are typically bounded by earthen dikes. No mixing devices are employed. Mixing in the pond is generated by the wind.

Another option for extensive ponds is the co-use with fish farming (e.g. catfish ponds). In this case waste products from the fish can be used at least in part as nutrients for the algae, and additional mixing is achieved through the aerators needed to supply the fish with sufficient oxygen.

The algal biomass is less concentrated in the extensive ponds than in the intensive ponds.

It has been observed that algae tend to concentrate in windrows at the edges of extensive ponds. The algae are often blown across the surface of the lake or pond where they collect and concentrate in windrows at the lee side. It has been recognized that the ability to harvest the windrows could significantly improve the process economics because of the higher concentration of algae.

It is not usually possible to consistently harvest windrows from a fixed harvesting plant site. Wind direction normally is somewhat unpredictable and may change frequently. The windrows may form at different locations along the side of the pond. When the windrow does not form at a fixed harvesting plant site, then a dilute suspension that is depleted in the algae is processed, which results in a reduced production rate. Harvesting costs are higher due to the processing costs associated with more dilute cultures.

Nevertheless, higher harvesting costs may be offset by the capital costs associated with constructing concrete and plastic lined ponds for intensive aquaculture. Pond construction costs per unit volume for the earthen extensive ponds are significantly lower than those for the lined concrete ponds of intensive aquaculture.

Dilute cultures of algae are generally uneconomical to process in part because of the problems and difficulties encountered in separating the algae from the water in which they grow (i.e., dewatering). The algae have a similar density as water (i.e. they are neutrally buoyant), are approximately 5 to 15 microns in size and have an elliptical shape, all of which makes them difficult to harvest.

Presently, algae is separated from the water within which it is found by using a chemical flocculating and/or coagulating agent in combination with a settler, centrifuge, filter or adsorbent, i.e. methods which either require large amounts of chemicals and/or power.

It would be desirable to more economically and efficiently harvest algae with minimal or no undesirable additives.

An alternative process for producing algae is by the use of a bioreactor, also called a photobioreactor when the system is exposed to sunlight. A bioreactor is a vessel in which is carried out a chemical process which involves organisms or biochemically active substances derived from such organisms. Bioreactors are commonly cylindrical, ranging in size from a few to hundreds of meters and are often made of stainless steel. In operation, water containing algae is fed into the bioreactor at a constant rate, and the bioreactor environment accelerates algae growth. Fouling can harm the overall sterility and efficiency of a bioreactor. To avoid such fouling, the bioreactor must be easily cleanable and must be as smooth as possible (i.e., a round shape is preferred).

It would be desirable to have an algae dewatering device which is useful in environments with low as well as high concentrations of algae and which would be configured to be located at the source of algae for efficient algae collection and dewatering.

### INCORPORATION BY REFERENCE

U.S. Patent Application Publication No. 2008-0128331-A1, published Jun. 5, 2008, entitled, “Particle Separation And Concentration System”; U.S. Patent Application Publication No. 2009-0114607A1, published on May 7, 2009, entitled, “Fluidic Device And Method For Separation Of Neutrally Buoyant Particles”; U.S. Patent Application Publication No. 09-0114601-A1, published May 7, 2009, entitled, “Device And Method For Dynamic Processing And Water Purification”; U.S. patent application Ser. No. 12/120,093, filed May 13, 2008 (Publication no. 2009-0283455, published Nov. 19, 2009), entitled, “Fluidic Structures For Membraneless Particle Separation”; U.S. patent application Ser. No. 12/120,153, filed May 13, 2008, entitled, “Method And Apparatus For Splitting Fluid Flow In A Membraneless Particle Separator System; and U.S. patent application Ser. No. 12/234,373, filed Sep. 19, 2008 (Publication No. 2010-0072142, published Mar. 25, 2010), entitled, “Method And System For Seeding With Mature Floc To Accelerate Aggregation In A Water Treatment Process”; U.S. Patent Application Publication No. 2010-0314263, published Dec. 16, 2010, entitled, “Stand-Alone Integrated Water Treatment System For Distributed Water Supply To Small Communities”; U.S. Patent Application Publication No. 2010-0314323, published Dec. 16, 2010, entitled, “Method And Apparatus For Continuous Flow Membrane-Less Algae Dewatering”; U.S. Patent Application Publication No. 2010-0314325, published Dec. 16, 2010, entitled, “Spiral Mixer For Floc Conditioning”; U.S. Patent Application Publication No. 2010-0314327, published Dec. 16, 2010, entitled, “Platform Technology For Industrial Separations”, all naming Lean et al. as inventors; and U.S. Pat. No. 7,160,025, issued Jan. 9, 2007, and entitled Micromixer Apparatus And Method Of Using Same”, to Ji et al.; are each hereby incorporated by reference in their entirety.

### BRIEF DESCRIPTION

In one aspect of the presently described embodiments, the system comprises an inlet to receive at least a portion of the fluid containing the neutrally buoyant algae, a curved or spiral channel within which the fluid containing algae flows in a manner such that the neutrally buoyant algae concentrate in a band offset from a center of the channel, a first outlet for the fluid with algae within which the band flows, and, a second outlet for the remaining fluid.

In another aspect of the presently described embodiments, the inlet is angled to facilitate earlier formation of the band along an inner wall of the spiral channel using a Coanda effect where wall friction helps to attach impinging flow.

In another aspect of the presently described embodiments, the method comprises receiving at least a portion of the fluid containing the neutrally buoyant particles at an inlet, establishing a flow of the fluid in a spiral channel wherein the neutrally buoyant particles concentrate in a band through the curved or spiral channel in an asymmetric manner, outputting the fluid within which the band flows through a first outlet of the channel, and, outputting the remaining fluid through a second outlet of the spiral channel.

### BRIEF DESCRIPTION OF THE DRAWINGS

FIG. 1 is an environment in which the present concepts are incorporated;

FIG. 2 depicts employment of the device of the present application at a dewatering site;

FIG. 3 is an alternative environment incorporating the present concepts;

FIG. 4 is a representation of a particle flowing through a channel and forces acting thereon;

FIG. 5 depicts a flow within the channels;

FIG. 6 illustrates an embodiment of a dewatering device/system according to the present application;

FIG. 7 is an alternative embodiment of a dewatering device/system;

FIG. 8 illustrates still a further embodiment according to the presently described embodiments;

FIG. 9 is yet a further embodiment;

FIG. 10 illustrates an electrocoagulation embodiment of the algae dewatering spiral separator system;

FIG. 11 illustrates a further embodiment of the algae dewatering spiral separator system;

FIG. 12 is a control system for the present application.

### DETAILED DESCRIPTION

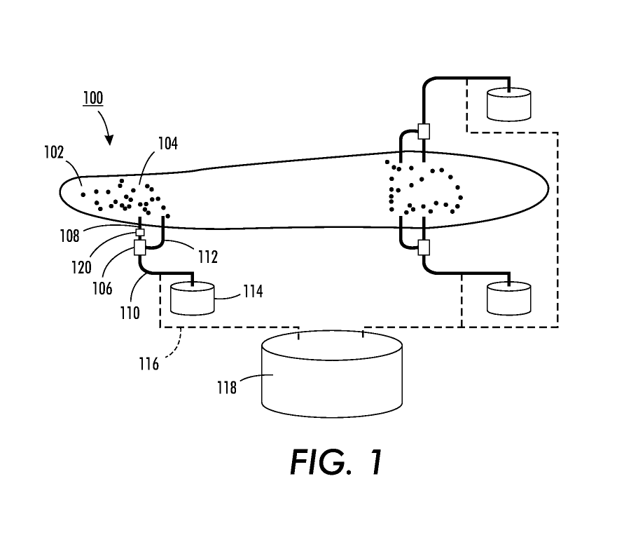

Illustrated in FIG. 1, is a pond 100 having water 102 with algae 104 suspended therein. Technical and economic problems in algae harvest are largely due to the size, specific gravity and morphology of the algae. A combination of small size (5-15 microns) and specific gravity similar to water (i.e., the neutral buoyancy of the algae) results in a settling rate that is too slow to permit the use of sedimentation as a routine procedure for harvesting the algae cells. Further, in settings where algae exists in (very) low concentrations, there are issues involving handling the large volumes of liquid needed to recover the comparatively small amount of algae.

Harvesting algae generally involves three steps. The first step, concentration or removal, increases the solid concentration in the form of about 0.02 to 0.04 percent weight to about 1 to 4 percent. The second step is dewatering, which then brings the solids to 8 to 25 percent. Depending on the biofuel recovery process, a third step may be needed in which the algae mass is dried to 85 to 92 percent solids by weight.

FIG. 1 further depicts a plurality of dewatering devices 106 configured in accordance with the concepts of the present application. A full description of the dewatering devices will be undertaken in the following sections.

With continuing attention to FIG. 1, it can be seen the plurality of dewatering devices 106 are positioned at different locations at pond 100. In operation, each of the dewatering devices 106 are connected to an input 108 to bring in algae-containing water 102, which is processed, whereby concentrated amounts of algae exit the device via an output 110. A return line 112 is also connected to the dewatering device 106 to receive water to be returned to the pond 100 from which the algae-laden water has been removed. Dewatering devices 106 are constructed with a controllable size limiting feature, whereby the percentage of algae removed from the water and output via output 110, and the amount of algae returned to the pond via return line 112, can be controlled such that not all algae is removed. Rather, algae of a certain size may be returned to the pond for further growth or for continued seeding of the pond. It is also noted that FIG. 1 also illustrates the concentrated algae from line 110 is deposited in the storage device 114, whereafter the high algae concentrated fluid from each tank is manually collected. Alternatively, each of the high concentration lines 110 are connected to portable piping 116, which lead to a centralized storage container 118. In another embodiment the concentrated algae from line 110 or from the storage device 114 is fed directly into a device that either dewaters the algae further.

It is noted with attention to FIG. 1, while the arrangement is designed to use gravity to supply the algae-containing water 102 to dewatering devices 106, in an alternative embodiment, a pump 120 is used. Particularly, it is desirable that a mobile harvesting pump is used to transfer the algae containing water 102 from pond 100 to dewatering devices 106. The pump 120 can be a floating pump or submersible pump, or may be mounted on a raft or other device that is locatable at the site of the algae.

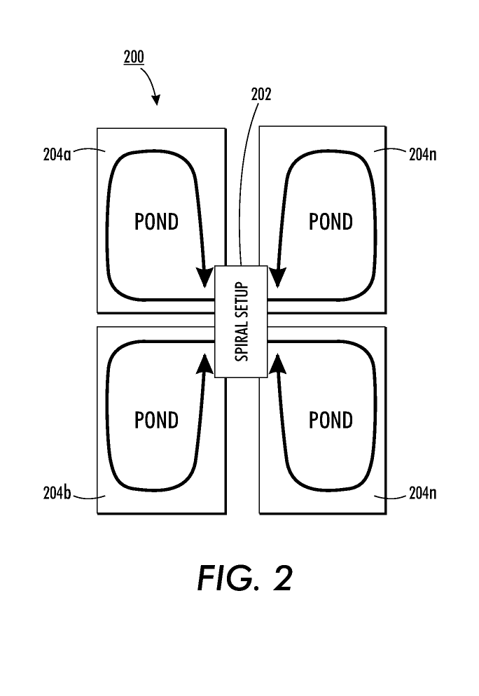

In another embodiment the dewatering devices are portable and allow their use at locations of the pond where the algae concentration is highest. The storage device 114 would be part of the portable setup to allow intermediate storage of concentrated algae before moving it on for further processing. FIG. 2 illustrates an open pond systems 200, which is distributed over large areas, and needs additional considerations to ensure optimal deployment of the dewatering devices 202. The solution will be a distributed system of dewatering devices where each device serves several ponds 204a-204n and the coverage will be to minimize pumping while maximizing local dewatering. A further consideration is the need for fluidic recirculation of the pond to bring fresh algae samples to the inlet of the dewatering device. This can be accomplished by positioning the effluent outlet so that fluid circulation brings fresh samples to the vicinity of the inlet.

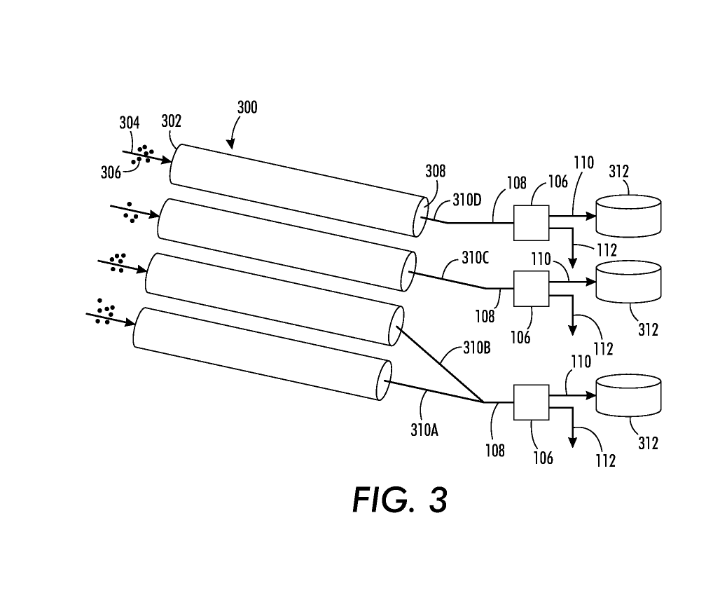

Turning to FIG. 3, illustrated is another embodiment in which dewatering devices 106 may be employed. Particularly shown is a plurality of bioreactors 300, each having inlets 302 to which water 304 having algae 306 suspended therein, is delivered. In the bioreactors 300, processes are undertaken to grow the algae 306 into high concentrations. The concentrated algae is then output via output openings 308. However, it is still necessary that the algae be separated or dewatered in an efficient manner. In this regard, the dewatering devices 106 are employed. In one embodiment, multiple flows 310a, 310b from bioreactors 300 are merged into a single flow and then delivered to dewatering devices 106, input via the line 108. Alternatively, individual flow 310c, 310d from bioreactors are provided to individual dewatering devices 106 such as by input lines 108. Similar to the description in regard to FIG. 1, outputs 110 of dewatering devices (i.e., 106) output a high concentration of algae to a holding tank 312. The water stream with a predetermined percentage of algae removed, is fed via output 112 back to an appropriate waste facility, back to the source of the water, or alternatively to further treatments to clarify the water for surface discharge.

The dewatering methods of the present application rely on the use of dewatering devices that employ spiral separation technology, where the dewatering devices have a small physical footprint. Because of the small footprint, the dewatering devices can be mounted on a flatbed truck, trailer, raft or other easily maneuverable transport device that is readily moved to or near the site of the algae.

The amount of algae that is obtained from the stream of water fed into the dewatering device can vary over a wide range of concentrations, from dilute suspensions to more concentrated suspensions. The present concepts are capable of dewatering dilute suspensions found in naturally occurring lakes and ponds, as well as diluting high concentrations such as in bioreactors.

As mentioned above, dewatering device 106, employs a spiral separation technology designed to concentrate neutrally buoyant materials, such as algae.

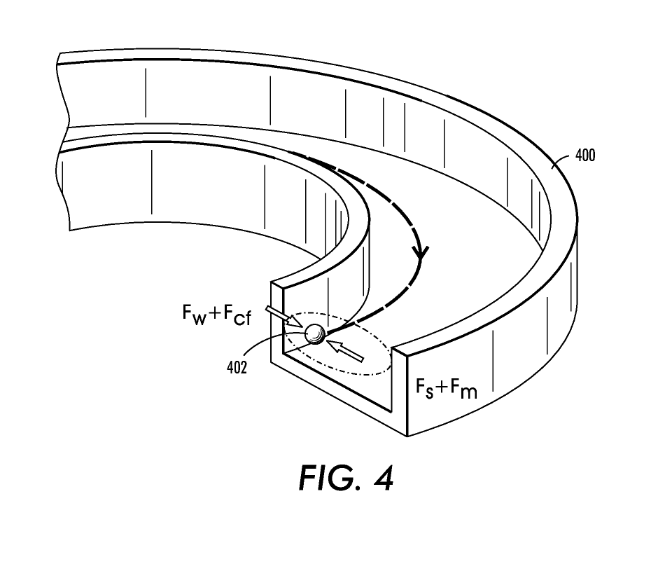

Turning now more particularly to the spiral separation concepts of the dewatering devices, FIG. 4 illustrates a curved channel 400 of a spiral device is used to introduce a centrifugal force upon neutrally buoyant particles 402 (e.g., particles such as algae having substantially the same density as water, or the fluid in which the particles reside) flowing in a fluid, e.g. water, to facilitate improved separation of such particles from the fluid into a concentrated mass. As these neutrally buoyant particles flow through the channel 400, a tubular pinch effect causes the particles to flow in a tubular band. The introduced centrifugal force perturbs the tubular band (e.g. forces the tubular band to flow in a manner offset from a center of the channel), resulting in an asymmetric inertial migration of the band toward either the inner or the outer wall of the channel (depending on channel geometry and flow rate). This force balance allows for focusing and compaction of suspended particulates into a narrow band for extraction. The separation principle contemplated herein implements a balance of the centrifugal and fluidic forces to achieve asymmetric inertial equilibrium near one of the sidewalls. Angled impingement of the inlet stream towards the inner wall also allow for earlier band formation due to a Coanda effect where wall friction is used to attach the impinging flow

With continuing reference to FIG. 4, the asymmetric tubular pinch effect in the channel is created by various forces, including a lift force F_{W} from the inner wall, a Saffman force F_{S}, Magnus forces Fₘ and a centrifugal force F_{cf}. It should be appreciated that the centrifugal force F_{cf} is generated as a function of the radius of curvature of the channel. In this regard, this added centrifugal force F_{cf} induces the slow secondary flow (a Dean vortex pair) (shown by the dashed arrows) which perturbs the symmetry of the regular tubular pinch effect. In essence, the Dean vortices sweep the neutrally buoyant suspensions and relocate them to a new position where there is a force equilibrium. Over time, the band forms as this location act as a focus for migrating suspensions. Depending on the channel geometry and the flow rate the particles are concentrated either at the inner or the outer side wall.

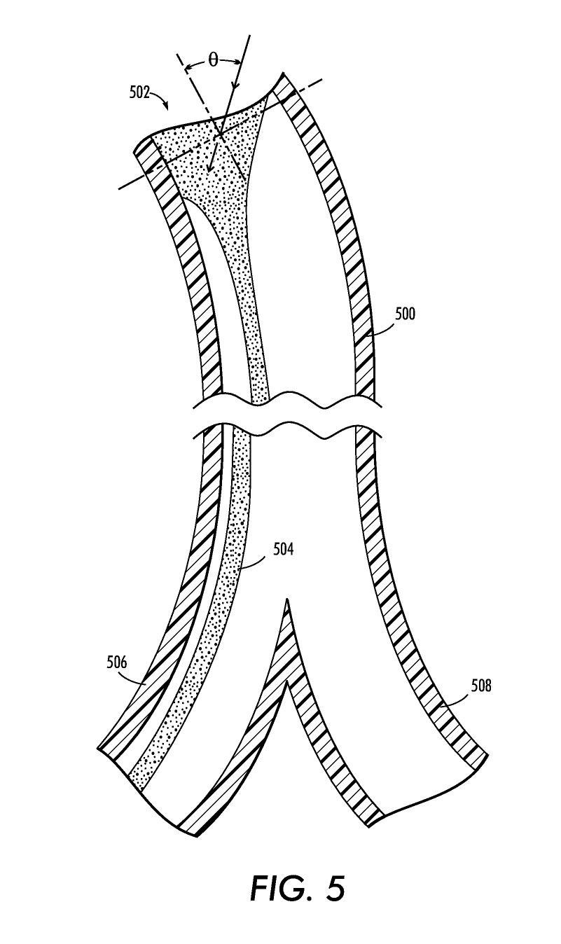

It should also be appreciated that the inlet in some embodiments provides an angled or inclined entry of fluid to the system to facilitate quicker formation of the tubular band along an inner wall of the spiral channel as shown in FIG. 5. This is the result of the Coanda effect where wall friction is used to attach the impinging flow. With continuing reference to FIG. 5, the channel 500 has an inlet 502 wherein the inlet stream is angled toward the inner wall by an angle θ. The tubular band 504 is thus formed earlier for egress out of the outlet 506. Of course, the second outlet 508 for the remaining fluid in which the band 504 does not flow is also shown. It should be understood that the inlet angle may be realized using any suitable mechanism or technique.

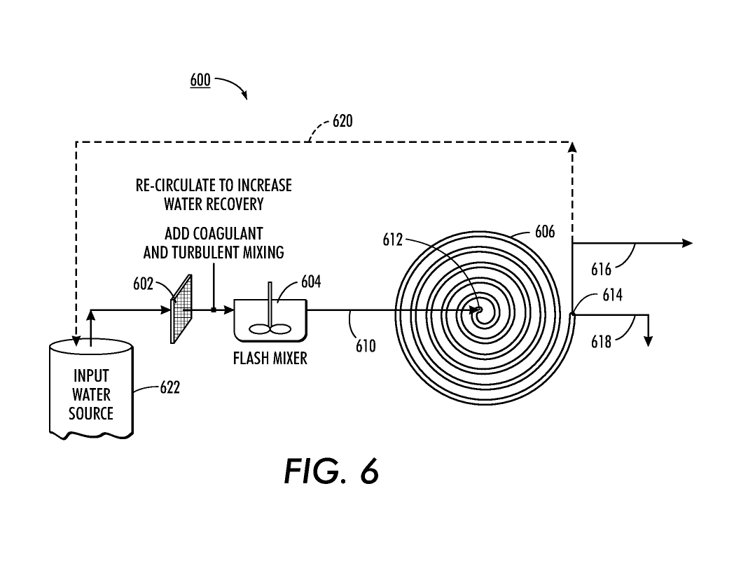

FIG. 6 illustrates one embodiment of a dewatering device 600 (such as might be employed as dewatering devices 106 of FIGS. 1 and 2) employing spiral separator concepts according to the presently described embodiments. As shown, the system includes a screen 602, and an optional flash mixer 604. The spiral device 606 according to the presently described embodiments includes an input line 610 to an inlet 612 as well as an outlet 614 providing output to first output 616 and a second output 614. Also shown in system 600 is a recirculation channel or path 620 which optionally recirculates water from outlet 612 to input water source 618 (and depending upon the embodiment may or may not be considered part of the dewatering device).

In operation, fluid containing neutrally buoyant particles is received in the system and first filtered through the screen 602. Coagulant can be added to the filtered water in the flash-mixer 604 if needed, before being introduced into the spiral device 606 through inlet 612. As the fluid flows in the spiral device 606, the band of neutrally buoyant particles is maintained to flow in an asymmetric manner, relative to the center of the channel. This asymmetry allows for convenient separation of the band (which is output through outlet 618). The clear effluent stream disposed of at output 616 or optionally re-circulated back to resupply input water source 620 with algae.

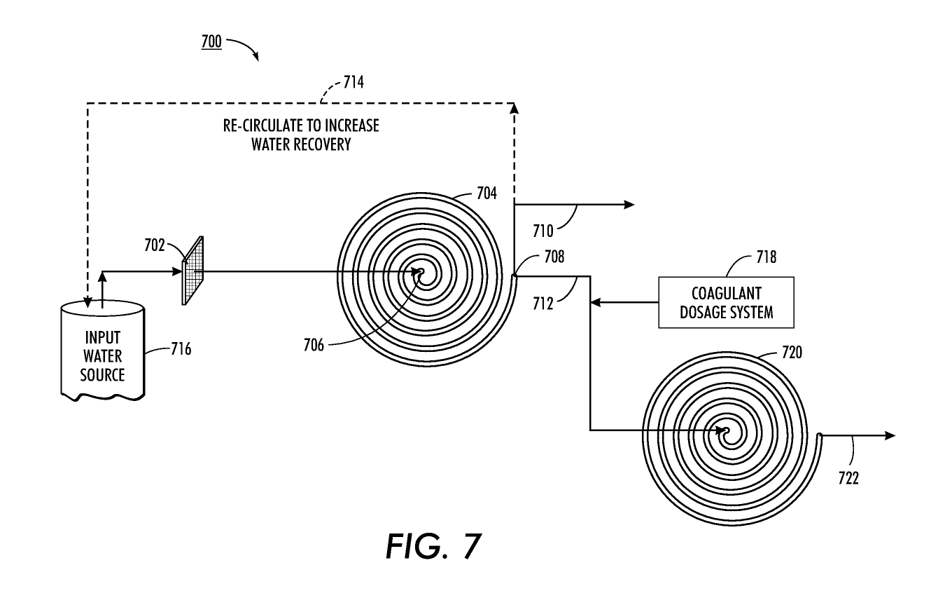

Turning to FIG. 7, illustrated is another embodiment of the dewatering device 106 of FIGS. 1 and 2. As shown, system 700 includes a screen 702. The spiral device 704 according to the presently described embodiments includes an inlet 706 as well as an outlet 708 providing output to a first output 710 and a second output 712. Also shown in system 700 is an optional recirculation channel or path 714 which recirculates water from outlet 708 to input water source 716. The water from output line 712 is treated with a well controlled dose of coagulant from coagulant dosage system 718 before it enters a second spiral mixer 720, where algae aggregate nucleation is initiated in a controlled manner for rapid aggregation in a subsequent sedimentation and further dewatering device. Additionally, spiral mixer 720 may also operate as a spiral mixer-conditioner, where mixing takes place in the channels of the turns operated at or above the critical Dean number (at or greater than 150), and aggregation conditioning occurs in the channels of the turns where the operation is below the critical Dean number.

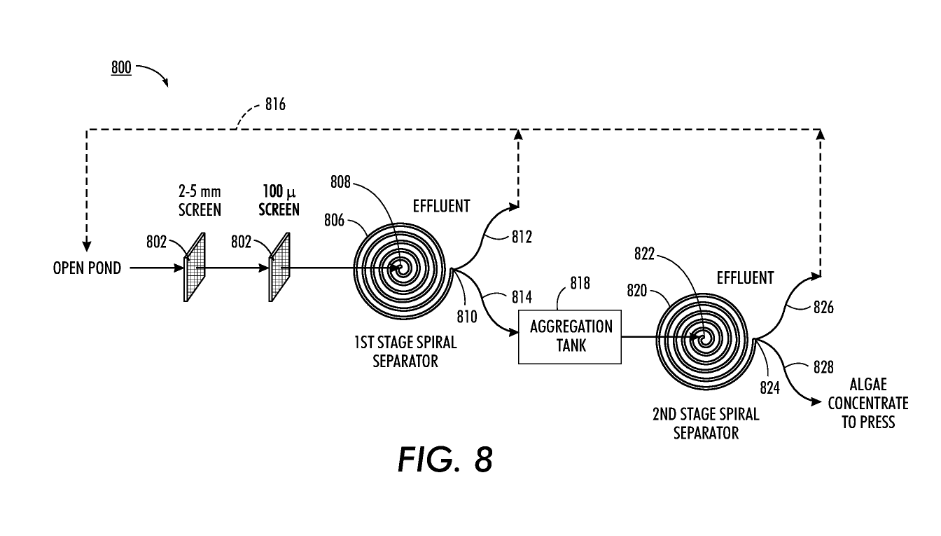

Turning to FIG. 8, illustrated is another embodiment of the dewatering devices 106 of FIGS. 1 and 2, incorporated in dewatering device/system 800 which includes two spiral separator devices 802 and 804. In operation, water containing algae from the input water source , such as a pond or other body of water, is input first to spiral separator device 806 via input 808. Spiral separator 806 includes an output 810 with a first outlet line 812 which contains a stream depleted of algae, which is optionally recycled back 816 into the input water source (e.g., the Open Pond). Outlet line 814 includes water with the neutrally buoyant algae and is provided to an aggregation tank 818 in system where additional aggregation may be beneficial. Following a predetermined time, the water is moved to the second spiral separator device 820 via input 822. Thereafter, the second spiral separator device 820 further concentrates the neutrally buoyant algae via a transverse hydrodynamic force separation, outputting the concentrated algae at output 824 via output line 828 for further processing. The stream of water with depleted algae is output via output line 826, which may be connected to re-circulation line 816, to provide the de-concentrated algae water to the input water source (e.g., the Open Pond). If an even higher concentration of algae is required, additional spiral separators can be added in a similar manner, where the output with the concentrated algae of one stage forms the input for the next stage, and the depleted water stream is recycled to the input water source.

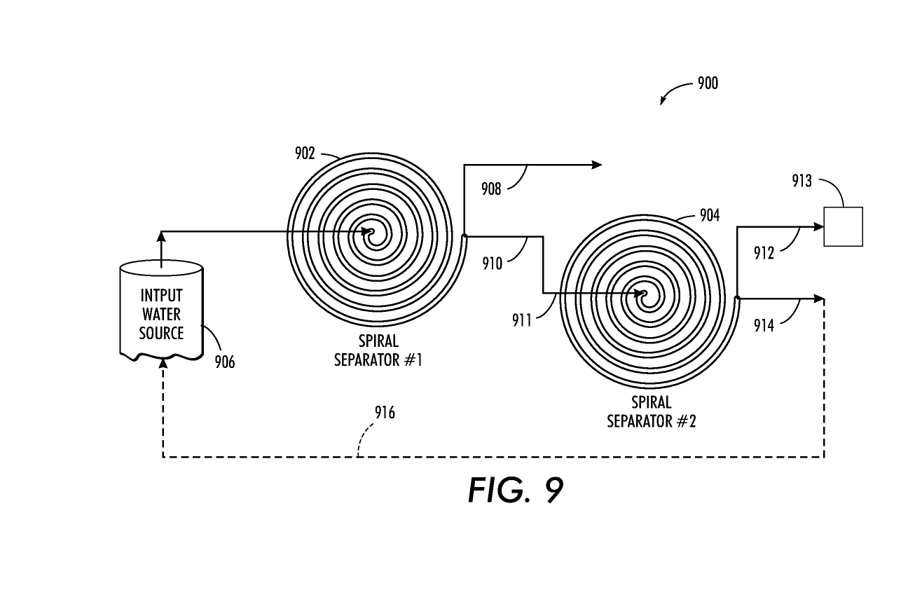

Alternatively, if the input water source contains a large amount of buoyant particles, as shown in FIG. 9, spiral separator 902 can be optimized to remove these denser particles before subsequent spiral separators concentrate the algae. In this embodiment, spiral separator 902 includes a first outlet line 908 which contains a concentrated amount of buoyant and denser particles (i.e., non-algae particles, which as previously mentioned are neutrally buoyant). Output line 910 includes water with the neutrally buoyant algae and is provided to second spiral separator device 904 via input line 911. Thereafter, the second spiral separator device 904 concentrates the neutrally buoyant algae via a transverse hydrodynamic force separation, outputting the concentrated algae via output line 912 to a container 913. The stream of water with depleted algae is output via output line 914, which may be connected to re-circulation line 916, to provide the de-concentrated algae water to input water source 906. If an even higher concentration of algae is required, additional spiral separators can be added in a similar manner, where the output with the concentrated algae of one stage forms the input for the next stage, and the depleted water stream is recycled to the input water source 906.

This embodiment also emphasizes that in some environments the need for coagulation and flocculation is not required, and the device shown in FIG. 9 may in alternative embodiments include simply second spiral separator 904. Therefore, spiral separator 902 is optional in this figure and may be considered in some embodiments to be removed such that the water from the input water source 506 is directly fed into spiral separator 904.

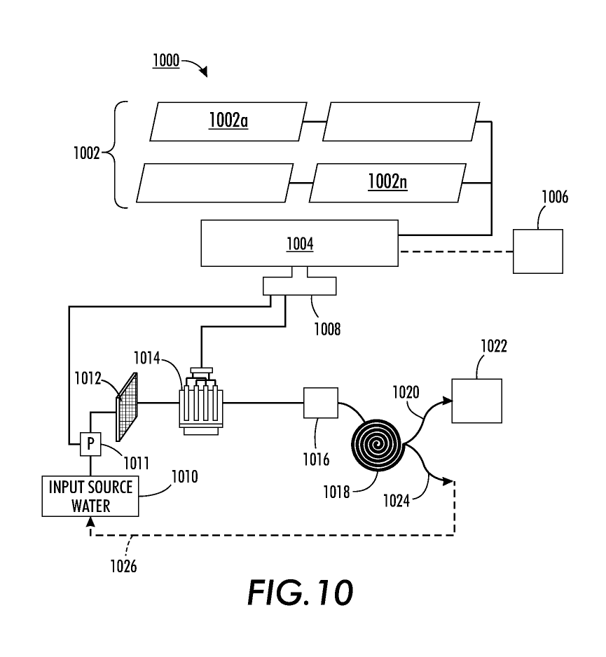

Turning to FIG. 10, depicted is an alternative dewatering device design, for the dewatering devices 106 of FIGS. 1 and 2, according to the present concepts.

Dewatering device 1000 includes solar (PV) power supply system 1002 which converts sunlight into electricity which is in turn stored in battery storage 1004. The solar power supply system 1002 is configured of multiple individual solar panels, such as 1002a-1002n, arranged in an appropriate configuration such as parallel and/or serial arrangements to provide the amount of energy needed to run device 1000. In an alternative embodiment, a manually operable generator or dynamo 1006 is included to generate power when sunlight is not available for conversion. An electrical power controller 1008 is provided in operative connection to battery storage 1004 to control the energy provided to components of dewatering device 1000 of FIG. 10.

In operation device 1000 receives source water 1010 via use of an optional input pump system 1011 supplied with power from controller 1008 at a suitable inlet (shown representatively) from an input water source that is, in one form, flowed through mesh filter 1012. It should be appreciated that mesh filter 1012 is designed to filter out relatively large particles from the input water. In this regard, the filter 1012 may be formed of a 2 mm-5 mm mesh material, although other sized filters may be used.

Water 1010 which has passed through filter 1012 is provided to an electrocoagulation system 1014. As illustrated in this drawing, electrocoagulation system 1014 is supplied with power, again by controller 1008. Water output from electrocoagulation system 1014 is then passed to the maturation buffer tank 1016.

The output from buffer tank 1016 is passed to spiral separator 1018 which has an output line 1020 within which is the concentrated algae, which is provided to a storage area 1022.

Spiral separator 1018 has a second output line 1024 which feeds an at least partially algae depleted stream of water to a feedback line 1026 to supply the input source water with algae of a certain size, not concentrated by spiral separator 1018.

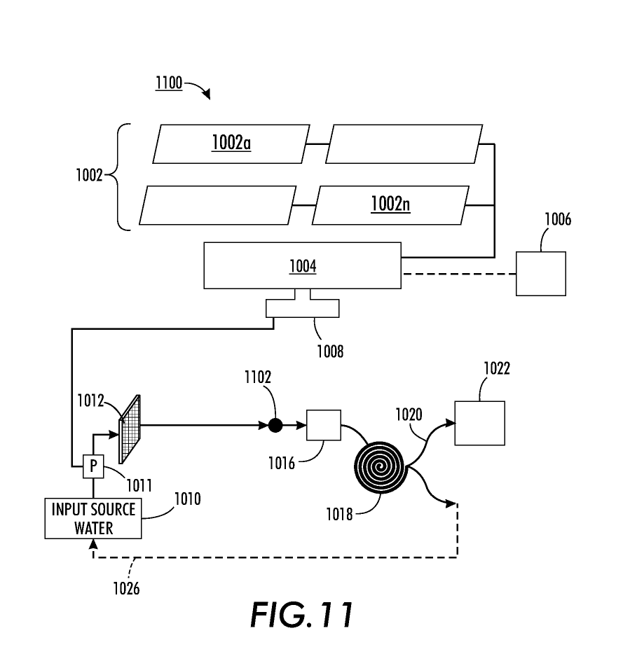

Turning to FIG. 11, set forth is a still further dewatering device 1100 according to the present concepts, similar to that of FIG. 10, wherein in place of the electrocoagulation system 1014, a spiral mixer 1102 is supplied wherein alkalinity and coagulant are added in-line such that coagulation and flocculation occur within the spiral mixer 1102 prior to being supplied to the maturation buffer tank 1022.

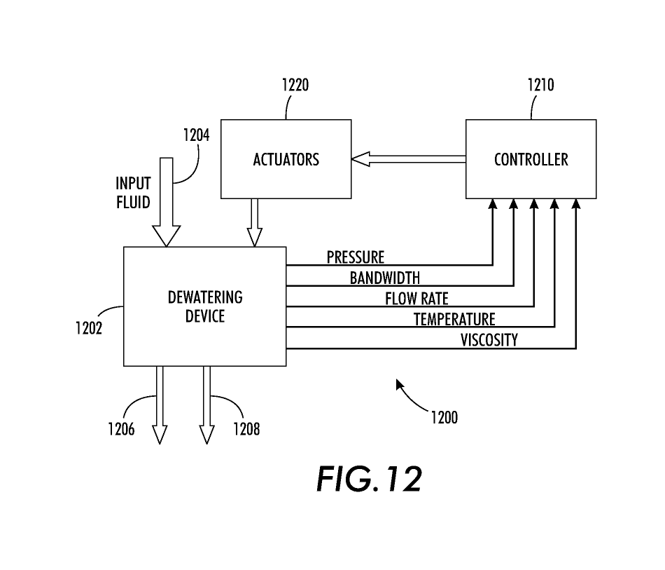

With reference now to FIG. 12, an example feedback and control system 1200 is illustrated. As shown, dewatering device 1202 (which could take the form of any of the spiral or other separators contemplated by the presently described embodiments or others) receives input fluid 1204 and processes it to achieve an algae concentrated stream 1206 and an algae depleted or de-concentrated stream 1208. The system 1200 may use various items of data, such as pressure, bandwidth, flow rate, temperature or viscosity—all of which may be measured using suitable sensors. The data is fed to a controller (which includes processors I/O elements, memory, among other components known and used in the controller industry) 1210 that controls various actuators 1220 that are operative to modify the performance of the device 1202 in a desired manner. Thus, FIG. 12 describes a feedback system which is capable of maintaining constant velocity of materials within the fluid channels of the various embodiments of the dewatering devices.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for continuous flow membrane-less algae concentration and dewatering of algae from a fluid, the method comprising:
receiving at least a portion of the fluid containing the algae at an inlet;
establishing a flow of the fluid in a spiral channel wherein the algae flow in a band through the curved channel in an asymmetric manner;
outputting the fluid with concentrated algae within which the band flows through a first outlet of the curved channel; and, outputting the remaining fluid through a second outlet of the curved channel.

2. The method as set forth in claim 1, wherein the dewatering device is membrane-less.

3. The method as set forth in claim 1, wherein the flow separates and focusses neutrally buoyant particles by use of hydrodynamic forces derived from an asymmetric tubular pinch effect.

4. The method as set forth in claim 1, wherein the first outlet carries between about 70% to 100% of the algae received by the curved channel and the second outlet carries between about 30% to 0% of the algae received by the curved channel.

5. The method as set forth in claim 1, wherein shearing flow through the curved channel causes the channel to be self cleaning.

6. The method as set forth in claim 1, wherein the inlet, the curved channel, the first outlet and the second outlet cooperate to concentrate buoyant and dense particles by use of centrifugal force and a flash mixer receives the fluid containing algae before the fluid enters the spiral channel.

7. The method as set forth in claim 1 wherein the inlet is angled to facilitate early formation of the band along an inner wall of the curved channel.

8. The method as set forth in claim 1 further comprising a second curved channel nested within the curved channel such that the band is narrowed as a result of flowing through the second curved channel.

9. The method as set forth in claim 1, further including the continued concentration of algae in the fluid by the outlet carrying the concentrated algae stream from the first spiral channel connecting to one or more further consecutive inlet spiral-channel-outlet configurations.

10. The method as set forth in claim 9, further including a coagulant dosage system and a spiral mixer for initiation of rapid aggregation of algae in a subsequent sedimentation and/or dewatering step, such coagulant dosage system and spiral mixer receiving the concentrated algae stream of the final spiral channel.

11. The method as set forth in claim 1 wherein the remaining fluid of the second outlet includes neutrally buoyant algae which are of a different size than the neutrally buoyant algae output through the first outlet.

12. A method as set forth in claim 11 wherein the neutrally buoyant algae in the second outlet stream are used to reseed the pond system with algae.
